(19) United States
(12) Patent Application Publication
(10) Pub. No.: US 2018/0126872 A1
(43) Pub. Date: May 10, 2018

(54) System and Method for Alerting a Presence of a Passenger in a Vehicle

(71) Applicant: Carmen Folino, Coral Springs, FL (US)

(72) Inventor: Carmen Folino, Coral Springs, FL (US)

(21) Appl. No.: 15/791,189

(22) Filed: Oct. 23, 2017

Related U.S. Application Data
(63) Continuation of application No. 62/419,866, filed on Nov. 9, 2016.

(51) Int. Cl. B60N 2/00; G08B 21/22; G08B 21/24; B60H 1/00

(52) U.S. Cl. CPC B60N 2/002; B60H 1/00742; G08B 21/24; G08B 21/22

(57) ABSTRACT

A system for alerting a presence of a passenger in a vehicle includes a sensor, a personal alarm, a vehicle alarm and a controller. The system for alerting a presence of a passenger in a vehicle is useful for detecting and alerting the presence of a passenger in a vehicle while the vehicle is in the parked state.

### CROSS-REFERENCE TO RELATED APPLICATION(S)

The present application is related to and claims priority to U.S. Provisional Patent Application No. 62/419,866 filed Nov. 9, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electronic communications of existing art and more specifically relates to land vehicle alarms or indicators.

### RELATED ART

Despite their best efforts, parents and guardians continue to accidentally leave children and pets in locked vehicles. Even in temperate climates, the consequences of leaving a loved one in a locked vehicle can be dire. In just twenty minutes, temperatures inside a vehicle can spike to dangerous highs and plummet to chilling lows. Without some sort of safety feature, parents and guardians may never know that they have left someone in such danger. If no one is alerted to the presence of a passenger in a locked vehicle, no one can help the passenger in their time of need. A suitable solution is desired.

U.S. Pat. No. 5,949,340 to Rossi relates to a warning system for detecting the presence of a child in an infant seat. The warning system for detecting the presence of a child in an infant seat includes an apparatus for warning when a child has been left in an infant seat and a vehicle has been turned off. The apparatus includes an occupant detection mechanism for detecting the presence of an occupant within an infant seat located within a vehicle. an ignition detection mechanism for detecting the state of the vehicle's ignition system, a control unit for generating an alarm signal when the occupant detection mechanism detects the presence of an occupant within the infant seat and the ignition detection mechanism detects that the vehicle's ignition system has been turned from an “on” state to an “off” state; and an alarm unit for generating an alarm in response to the alarm signal. The components of the apparatus can be located within the infant seat, within the vehicle or combined within the infant seat and the vehicle.

### SUMMARY OF THE INVENTION

In view of the foregoing disadvantages inherent in the known land vehicle alarms or indicators art, the present disclosure provides a novel system for alerting a presence of a passenger in a vehicle. The general purpose of the present disclosure, which will be described subsequently in greater detail, is to provide a system for alerting a presence of a passenger in a vehicle.

A system for alerting a presence of a passenger in a vehicle is disclosed herein. The system for alerting a presence of a passenger in a vehicle includes a sensor configured to detect the presence of a passenger in the vehicle, a personal alarm configured to sound a first alert, the personal alarm being mobile from the vehicle, a vehicle alarm configured to sound a second alert and a controller communicably coupled to the vehicle, to the sensor, to the personal alarm, and to the vehicle alarm, the controller configured to determine a parked state of the vehicle. The controller is further configured to activate at least one of the personal alarm and the vehicle alarm upon detecting the presence of the passenger in the vehicle for a predetermined time while the vehicle is in the parked state.

According to another embodiment, a method for alerting a presence of a passenger in a vehicle is also disclosed herein. The method for alerting a presence of a passenger in a vehicle includes installing a sensor to the rear-view mirror of a vehicle, the sensor configured to detect passengers within the cabin of a vehicle, providing a personal alarm which is mobile from the vehicle, installing a mobile application on a mobile device, the mobile application configured to wirelessly communicate with the personal alarm, and a installing a controller into a vehicle, the controller communicably coupled to the sensor, to the personal alarm and to the vehicle alarm, the controller configured to activate at least one of the personal alarm and the vehicle alarm upon detecting the presence of the passenger in the vehicle for a predetermined time while the vehicle is in a parked state.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system for alerting a presence of a passenger in a vehicle, constructed and operative according to the teachings of the present disclosure.

FIG. 1 is a perspective view of the system for alerting a presence of a passenger in a vehicle during an ‘in-use’ condition, according to an embodiment of the disclosure.

FIG. 2 is a perspective view of a detail of the system for alerting the presence of the passenger in a vehicle of FIG. 1, according to an embodiment of the present disclosure.

FIG. 3 is a perspective view of a detail of the system for alerting the presence of the passenger in a vehicle of FIG. 1, according to an embodiment of the present disclosure.

FIG. 4 is a perspective view of aspects of the system for alerting a presence of a passenger in a vehicle of FIG. 1, according to an embodiment of the present disclosure.

FIG. 5 is a flow diagram illustrating a method of use for alerting a presence of a passenger in a vehicle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a land vehicle alarms or indicators and more particularly to a system for alerting a presence of a passenger in a vehicle as used to improve the alerting of a presence of a passenger in a vehicle.

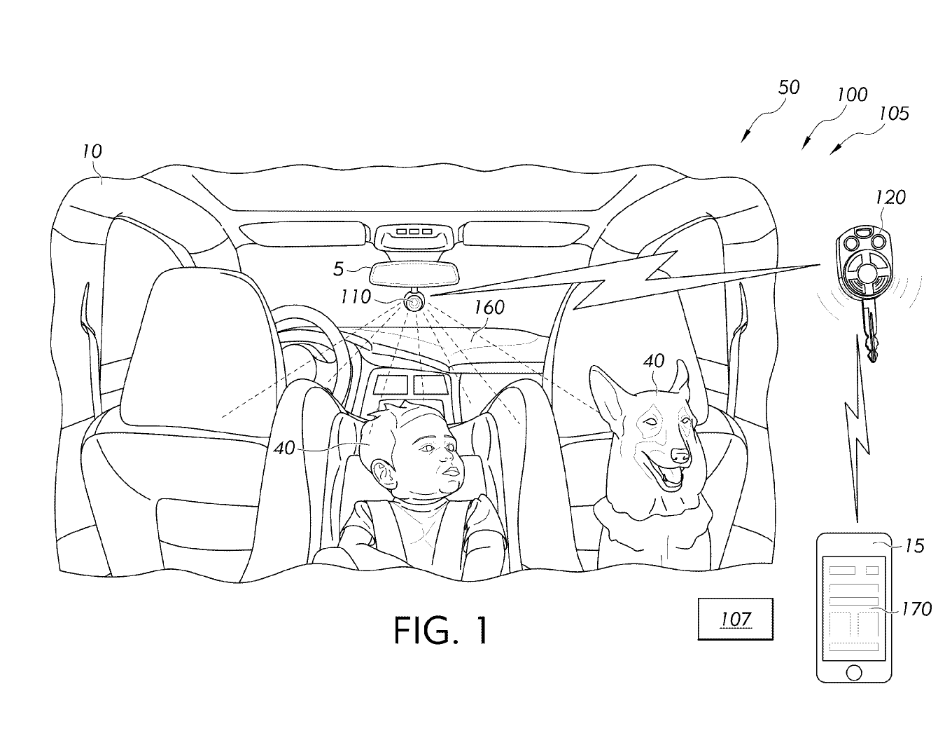

Referring to the drawings by numerals of reference, there is shown in FIGS. 1-4, various views of a system 100 for alerting a presence of a passenger 40 in a vehicle 10 (hereinafter “the system 100”). Generally, the system 100 may be useful in preventing death and injury to individuals left behind in a vehicle 10. The system 100 may include a sensor 110, the sensor 110 being configured to detect the presence of a passenger within the cabin of a vehicle 10.

The system 100 may further include a personal alarm 120, such as a key fob remote 300, wherein the personal alarm 120 is configured to emit an audible alarm. It should be noted that the personal alarm 120 is mobile from the vehicle 10 allowing it to be carried on the person of a user (e.g., the driver). Furthermore, the system 100 may include a vehicle alarm 130, the vehicle alarm 130 may be configured to sound an audible alarm after a predetermined interval of time has elapsed and the passenger has not been removed from the cabin of the vehicle 10.

Finally, the system 100 may include a controller 160, the controller 160 being communicably coupled to the vehicle 10, to the sensor 110, to the personal alarm 120, and to the vehicle alarm 130. The controller 160 component of the system 100 may be configured to detect a parked state of the vehicle 10. The controller 160 may further be configured to send a signal to the sensor 110 upon detecting a parked state of the vehicle 10. Furthermore, upon detecting a passenger while the vehicle 10 is in a parked state, the controller 160 may be configured to activate at least one personal alarm 120 and at least one vehicle alarm 130 if the passenger is not removed from the cabin of the vehicle 10 after a predetermined time interval has elapsed.

FIG. 1 shows the system 100 for alerting the presence of the passenger 40 in the vehicle 10 during an ‘in-use’ condition 50, according to an embodiment of the present disclosure. Here, the system 100 may be beneficial for use by a user (e.g., a driver, parent, etc.) to alert a presence of a passenger in a vehicle 10. As illustrated, the system 100 may include the sensor 110. The sensor 110 may be mounted to a rear-view mirror 5 in a vehicle 10. The system 100 may further include the controller 160. The controller 160 may include at least one transponder. The controller 160 may further include a timer, the timer being set at a predetermined time interval.

The sensor 110 may be configured to detect the presence of the passenger, and to transmit a presence signal to the controller 160 when in response to detecting the presence of the passenger when the vehicle 10 is in a parked state. The controller 160 may further be configured to transmit an alarm signal to the personal alarm 120. As shown, the personal alarm 120 may further be configured to transmit an alarm signal to the mobile device 15, and the alarm signal transmitted to the mobile device 15 is communicated to and used to display alert information via the mobile application 170 of the mobile device 15. The mobile application 170 may be further configured to activate a notification or alarm of the mobile device 15 in response to the alarm signal communicated to the mobile application 170.

According to one embodiment, the system 100 may be arranged as a kit 105. In particular, the system 100 may further include a set of instructions 107. The instructions 107 may detail functional relationships in relation to the structure of the system 100 such that the system 100 can be used, maintained, or the like, in a preferred manner.

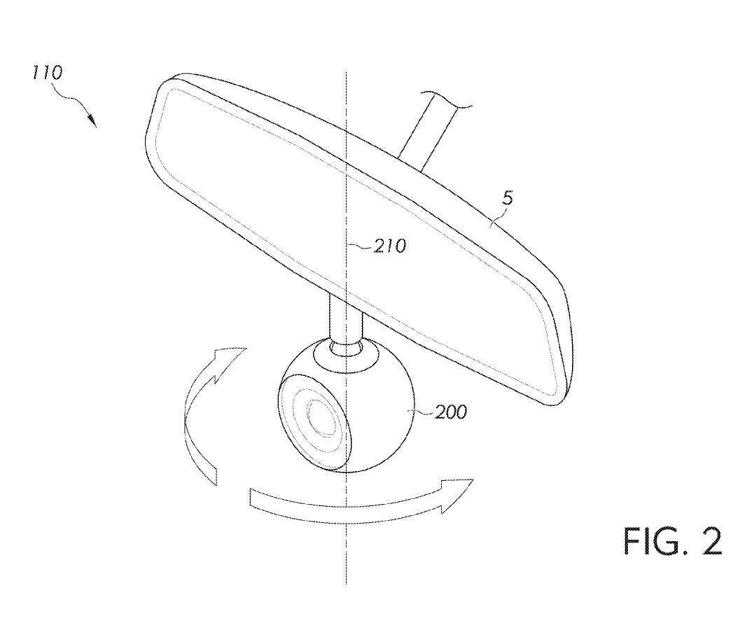

FIG. 2 shows a detail of the system for alerting the presence of the passenger in the vehicle of FIG. 1, according to an embodiment of the present disclosure. As above, the system 100 (FIG. 1) may include the sensor 110 mounted to a rear-view mirror 5. The sensor 110 may include an infrared camera 200.

The infrared camera 200 may include a rotation axis 210. Here, the rotation axis 210 is illustrated as being vertical, and providing a planar camera sweep in a horizontal plane. In other embodiments, the rotation axis 210 may be cantered or the rotation axis 210 may have multiple degrees of freedom. According to one embodiment, the infrared camera 200 may be configured to rotate at least 180 degrees about the rotation axis 210. The rotation axis 210 and/or a view angle of the infrared camera 200 may be adjusted to scan the entirety of the cabin of the vehicle 10 to detect any passengers which may be present. As above, upon detection of a passenger, the infrared camera 200 may send a passenger detection signal to the controller 160.

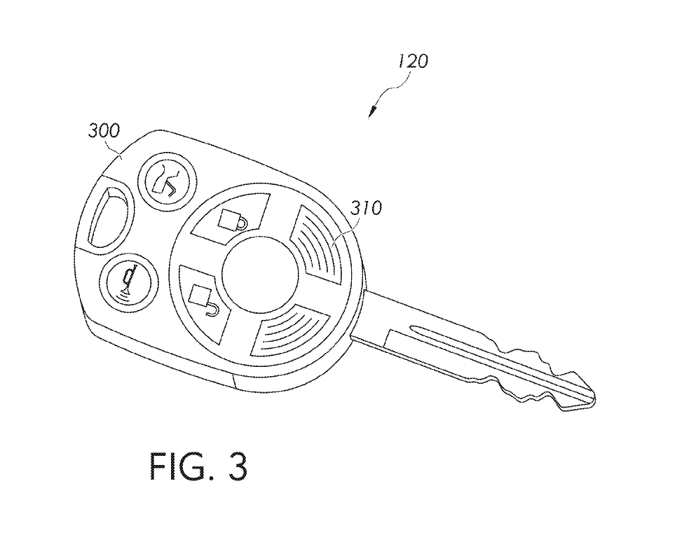

FIG. 3 shows a detail of the system for alerting a presence of a passenger in a vehicle of FIG. 1, according to an embodiment of the present disclosure. Depicted is the personal alarm 120, the personal alarm 120 including a key fob remote 300. The key fob remote 300 is readily mobile from the vehicle and may be carried on the person of a user (e.g., the driver). The key fob remote 300 may include at least one speaker 310, the speaker 310 configured to emit an audible alarm upon receiving an alarm signal from the controller 160. Furthermore, the key fob remote 300 may be configured to transmit an alarm signal to a mobile device 15 (FIG. 1), the signal then being communicated to the mobile application 170 (FIG. 1) resident and operating on the mobile device 15. The mobile application 170 may be configured to activate a notification or alarm of the mobile device 15 in response to the alarm signal communicated to the mobile application 170.

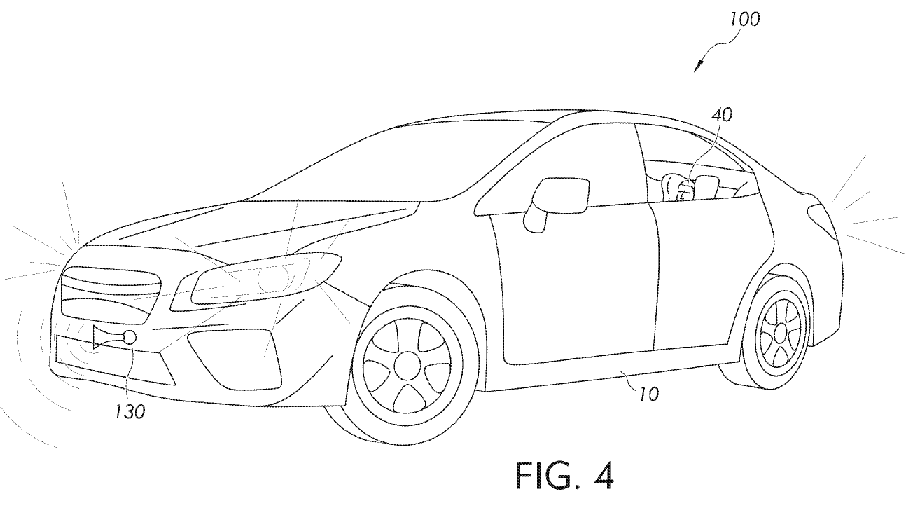

FIG. 4 is a perspective view aspects of the system 100 for alerting the presence of the passenger 40 in the vehicle 10 of FIG. 1, according to an embodiment of the present disclosure. The system 100 includes a controller 160 (FIG. 1), the controller 160 being further configured to activate the vehicle alarm 130 upon detecting the presence of the passenger 40 in the vehicle 10 for the predetermined time while the vehicle is in the parked state, and to re-activate the vehicle alarm 130 when the predetermined time interval has expired and the presence of the passenger in the vehicle 10 is still detected and the vehicle 10 is in the parked state. As is customary, the vehicle 10 may include a window control and a door lock control (not shown), and as such, the controller 160 may further be communicably coupled to the window control and the door lock control of the vehicle 10. Furthermore, the controller 160 may be configured to lower windows (as shown) and unlock doors of the vehicle 10 when the vehicle alarm 130 is activated in response to the passenger 40 being detected within the vehicle 10 while the vehicle 10 is in the parked state.

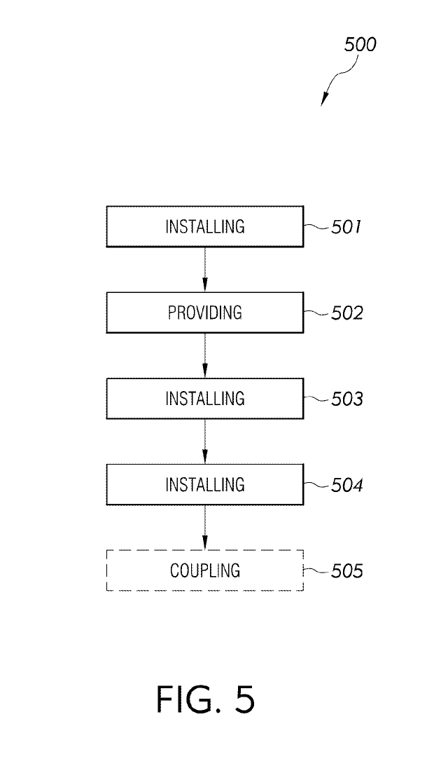

FIG. 5 is a flow diagram illustrating a method for alerting a presence of a passenger in a vehicle (hereinafter “the method”), according to an embodiment of the present disclosure. In particular, the method 500 may include one or more components or features of the system for alerting a presence of a passenger in a vehicle 100 as described above. As illustrated, the method 500 may include the steps of: step one 501, installing a sensor to a rear-view mirror of a vehicle, the sensor configured to detect a presence of a passenger within the cabin of the vehicle; step two 502, providing a personal alarm, the personal alarm being mobile from the vehicle; step three 503, installing a mobile application on a mobile device, the mobile application configured to wirelessly communicate with the personal alarm; step four 504, installing a controller into a vehicle, the controller communicably coupled to the sensor, to the personal alarm and to the vehicle alarm, the controller configured to activate at least one of the personal alarm and the vehicle alarm upon detecting the presence of the passenger in the vehicle for a predetermined time while the vehicle is in a parked state; and step five 505, coupling the controller to a window control system and a door lock system of the vehicle.

It should be noted that step five 505 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for system for alerting a presence of a passenger in a vehicle 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for alerting a presence of a passenger in a vehicle, the system comprising:
a sensor configured to detect the presence of a passenger in the vehicle;
a personal alarm configured to sound a first alert, the personal alarm being mobile from the vehicle;
a vehicle alarm configured to sound a second alert; and
a controller communicably coupled to the vehicle, to the sensor, to the personal alarm, and to the vehicle alarm, the controller configured to determine a parked state of the vehicle, and further configured to activate at least one of the personal alarm and the vehicle alarm upon detecting the presence of the passenger in the vehicle for a predetermined time while the vehicle is in the parked state.

2. The system of claim 1, wherein the sensor includes an infrared camera.

3. The system of claim 2, wherein the vehicle has a rear-view mirror; and
wherein the infrared camera is mounted to the rear-view mirror of the vehicle.

4. The system of claim 2, wherein the infrared camera includes a rotation axis, and the infrared camera is configured to rotate at least 180 degrees about the rotation axis.

5. The system of claim 2, wherein the infrared camera is configured to detect a presence of a passenger, and to transmit a presence signal to the controller in response to detecting the presence of the passenger when the vehicle is in a parked state.

6. The system of claim 5, wherein the controller is further configured to transmit an alarm signal to the personal alarm.

7. The system of claim 6, wherein the personal alarm includes a key fob remote, said key fob remote including at least one speaker configured to emit an audible alarm.

8. The system of claim 6, wherein the personal alarm is further configured to emit an audible alarm in response to the alarm signal.

9. The system of claim 6, further comprising a mobile device; and
wherein the personal alarm is configured to transmit the alarm signal to the mobile device.

10. The system of claim 9, wherein the mobile device includes a mobile application installed and executable on the mobile device; and
wherein the alarm signal transmitted to the mobile device is communicated to the mobile application of the mobile device.

11. The system of claim 10, wherein the mobile application is configured to activate a notification or alarm of the mobile device in response to the alarm signal communicated to the mobile application.

12. The system of claim 1, wherein the controller includes at least one transponder.

13. The system of claim 1, wherein the controller includes a timer, said timer being set at a predetermined time interval.

14. The system of claim 13, wherein the controller is further configured to activate the vehicle alarm upon detecting the presence of the passenger in the vehicle for the predetermined time while the vehicle is in the parked state, and to re-activate the vehicle alarm when the predetermined time interval has expired and the presence of the passenger in the vehicle is still detected and the vehicle is in the parked state.

15. The system of claim 1, wherein the vehicle includes a window control and a door lock control; and
wherein the controller is also communicably coupled to the window control and the door lock control of the vehicle.

16. The system of claim 15, wherein the controller is further configured to lower windows and unlock doors of the vehicle when the vehicle alarm is activated in response to a passenger being detected within the vehicle while the vehicle is in the parked state.

17. A system for alerting a presence of a passenger in a vehicle, the system comprising:
a sensor configured to detect the presence of a passenger in the vehicle;
a personal alarm configured to sound a first alert, the personal alarm being mobile from the vehicle;
a vehicle alarm configured to sound a second alert;
a controller communicably coupled to the vehicle, to the sensor, to the personal alarm, and to the vehicle alarm, the controller configured to determine a parked state of the vehicle, and further configured to activate at least one of the personal alarm and vehicle alarm upon detecting the presence of the passenger in the vehicle for a predetermined time while the vehicle is in the parked state; and
a mobile device; and
wherein the sensor includes an infrared camera;
wherein the vehicle has a rear-view mirror;
wherein the infrared camera is mounted to the rear-view mirror of the vehicle;
wherein the infrared camera includes a rotation axis, and the infrared camera is configured to rotate at least 180 degrees about the rotation axis;
wherein the infrared camera is configured to detect a presence of a passenger, and to transmit a presence signal to the controller in response to detecting the presence of the passenger when the vehicle is in a parked state;
wherein the controller is further configured to transmit an alarm signal to the personal alarm;
wherein the personal alarm includes a key fob remote, said key fob remote including at least one speaker configured to emit an audible alarm;
wherein the personal alarm is further configured to emit an audible alarm in response to the alarm signal;
wherein the personal alarm is configured to transmit the alarm signal to the mobile device;
wherein the mobile device includes a mobile application installed and executable on the mobile device; and
wherein the alarm signal transmitted to the mobile device is communicated to the mobile application of the mobile device;
wherein the mobile application is configured to activate a notification or alarm of the mobile device in response to the alarm signal communicated to the mobile application;
wherein the controller includes at least one transponder;
wherein the controller includes a timer, said timer being set at a predetermined time interval;
wherein the controller is further configured to activate the vehicle alarm upon detecting the presence of the passenger in the vehicle for the predetermined time while the vehicle is in the parked state, and to re-activate the vehicle alarm when the predetermined time interval has expired and the presence of the passenger in the vehicle is still detected and the vehicle is in the parked state;
wherein the vehicle includes a window control and a door lock control;
wherein the controller is also communicably coupled to the window control and the door lock control of the vehicle;
wherein the controller is further configured to lower windows and unlock doors of the vehicle when the vehicle alarm is activated in response to a passenger being detected within the vehicle while the vehicle is in the parked state.

18. The system of claim 17, further comprising set of instructions; and
wherein the system is arranged as a kit.

19. A method for alerting a presence of a passenger in a vehicle, the vehicle having a vehicle alarm, the method comprising the steps of:
installing a sensor to a rear-view mirror of a vehicle, the sensor configured to detect a presence of a passenger within the cabin of the vehicle;
providing a personal alarm, the personal alarm being mobile from the vehicle;
installing a mobile application on a mobile device, the mobile application configured to wirelessly communicate with the personal alarm;
installing a controller into a vehicle, the controller communicably coupled to the sensor, to the personal alarm and to the vehicle alarm, the controller configured to activate at least one of the personal alarm and the vehicle alarm upon detecting the presence of the passenger in the vehicle for a predetermined time while the vehicle is in a parked state.

20. The method of claim 19, further comprising the steps of coupling the controller to a window control system and a door lock system of the vehicle.
